(19) United States
(12) Patent Application Publication
(10) Pub. No.: US 2020/0068772 A1
(43) Pub. Date: Mar. 5, 2020

(54) Pinch Point Pull Hoe

(71) Applicant: Carl Turner, Beloit, WI (US)

(72) Inventor: Carl Turner, Beloit, WI (US)

(21) Appl. No.: 16/371,482

(22) Filed: Apr. 1, 2019

Related U.S. Application Data
(60) Provisional application No. 62/724,012, filed on Aug. 28, 2018.

(51) Int. Cl. A01B 1/20; A01B 1/14; A01G 3/00

(52) U.S. Cl. CPC A01B 1/20; A01G 3/00; A01B 1/14

(57) ABSTRACT

Embodiments are provided for a garden hoe that is made up of a head member that has a first point section, an intermediate section that is capable of forming an acute angle and attaching to an elongated handle, and a second point section. In one embodiment, the first point section is offset from the intermediate section, and the second point section is offset opposite to the first point section from the intermediate section. The first and second point sections further have a plurality of V-shaped notches and a plurality of V-shaped points.

### CROSS-REFERENCE TO RELATED APPLICATIONS

This application claims priority to U.S. Provisional Application No. 62/724,012 filed Aug. 28, 2018, which is incorporated by reference in its entirety.

### FIELD OF THE DISCLOSURE

This disclosure relates generally to novel garden hoes, especially to hoes for use in facilitating scything, chipping, pinching and cutting as well as hoeing in the popular sense during hand cultivation of soil thereof, and for performing a wide variety of other functions relative thereto.

### BACKGROUND

Many, if not most, users of the hoe are susceptible to the standard chop function of a straight thin blade to cultivate, cut weeds, and to aerate soil around vegetables and many other plants.

A wide variety of traditional garden hoes have been implemented for the purpose of hoeing, primarily in nurseries, weeding, gardening, and a serrated type for slide hoeing. Some of these traditional hoes include a flat piece of metal sharpened on one edge and with the upper corners clipped, plus means to attach to a handle. It is more or less straight up and down and smaller, and used for cultivation in nurseries.

Another type of hoeing tool that is traditionally used is a narrow strip of metal with a sharpened edge on the bottom and prongs protruding from the top portion. This type of hoe is used for weeding.

Further examples of known hoes consist of a flat piece of metal with the bottom edge sharpened. The top portion is rounded off and contains means to attach to a handle. This type of hoe is often used for gardening.

None of these known hoe examples perform to the complete satisfaction of the user in that certain plants are impervious to the stroke of an edge on a flat piece of metal. Further, many of the hoes in the prior art can only cut plants on one end of the hoe, can only be pulled in one direction, and do not allow a user to utilize forward motion to get to hard to reach weeds. Most users, therefore, would find it desirable to have a tool which could facilitate the pinching and cutting and removal of large fibrous weeds, small bushes and other resistant growth with the same tool.

### SUMMARY

The disclosure presented herein relates to garden hoe that is made up of a head member comprising a first point section, an intermediate section that is capable of forming an acute angle and attaching to an elongated handle, and a second point section. In one embodiment, the first point section is offset from the intermediate section, and the second point section is offset opposite to the first point section from the intermediate section. The first and second point sections further comprise a plurality of V-shaped notches and a plurality of V-shaped points. Further, the present invention relates to an attachment point, whereby a hoe handle attaches to the head of a hoe using a wedge. Those of ordinary skill will appreciate that other uses may be foreseeable also and are included within the scope of the present description.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure. Also, the drawings included herein are considered by the applicant to be informal.

FIG. 1 is perspective view of a gardening tool according to various aspects of the present disclosure.

FIG. 2 is top down view of a gardening tool as shown in FIG. 1.

FIG. 3 is a side view of the gardening tool as shown in FIG. 1.

FIG. 4 is a bottom view of the gardening tool as shown in FIG. 1.

FIG. 5 is an exploded view of the gardening tool as shown in FIG. 1.

FIG. 6 is a close-up view of the head member of the gardening tool as shown in FIG. 1.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40%or less than 40%. When, in this specification, a range is given as “(a first number) to (a second number)” or “(a first number)−(a second number),” this means a range whose limit is the second number. For example, 25 to 100 mm means a range whose lower limit is 25 mm and upper limit is 100 mm.

The gardening tool of the present disclosure may be used for the gardening or weeding of any garden or yard and allows the user to easily weed or garden using a pulling motion where the V-shaped points and V-shaped notches allow for the pinching of the vegetation between the V-shaped points in the V-shaped notch and cutting of said vegetation due to the sharpness of the V-shaped points and notches. Further, the present invention, because of the front set of V-shaped points and notches, allows a user to use to push the gardening tool to allow the user to remove unwanted vegetation in hard to reach places, such as underneath a fence, where the pulling of traditional gardening tools would not be adequate to reach. Persons having ordinary skill in the art relevant to the present disclosure may understand there to be equivalent elements that may be substituted with the present disclosure without changing the essential function or operation of the device.

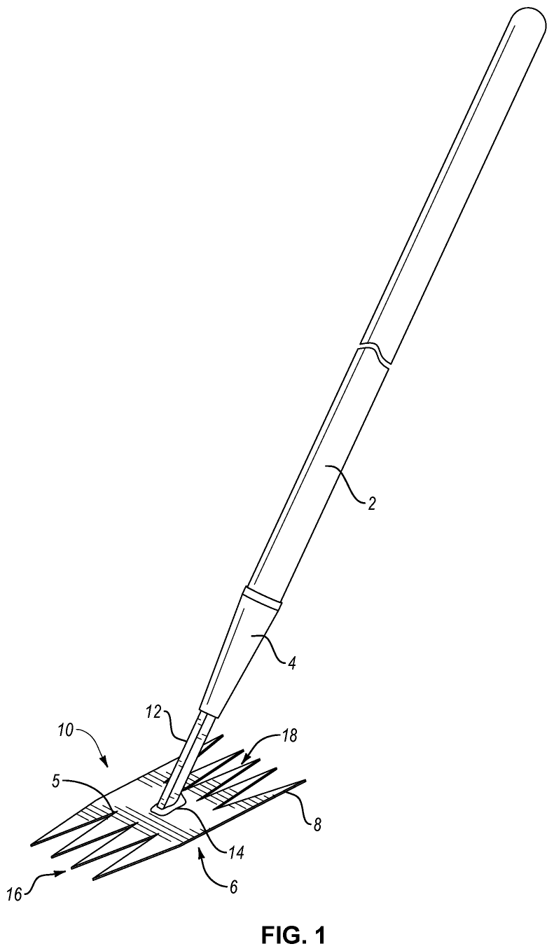

FIG. 1 is perspective view of a gardening tool according to various aspects of the present disclosure. In this view, gardening head 10 can be seen, with the first point section 18, the intermediate section 6, and the second point section 16 shown. In this embodiment, the first point section 18 is offset from the intermediate section 6, and the second point section 16 is offset to the first point section 18 from the intermediate section 6.

The first 18 and second 16 point sections are comprised of a plurality of V-shaped notches 5, and a plurality of V-shaped points 8.

In one embodiment, the head member is cut from one square sheet of metal, whereby the metal through the metal in a jagged, or V shaped pattern, forming the first and second point sections. In this embodiment, the none pointed ends of the first and second point sections are attached together to form the head member, and more specifically, the none pointed end of the point sections, once attached, form the intermediate section. This embodiment allows for efficient manufacturing as only one cut needs to be made to form both point sections.

Further, FIG. 1 shows from the intermediate section 6, the elongated handle 12 is attached to the head member 10 of the gardening tool. The elongated handle 12 is attached to the holding handle 2 by the attachment piece 4. In use, a user uses the gardening tool by holding the holding handle 2. The holding handle, in one embodiment, is made out of wood, but can be made out of any material commonly used to make gardening tools.

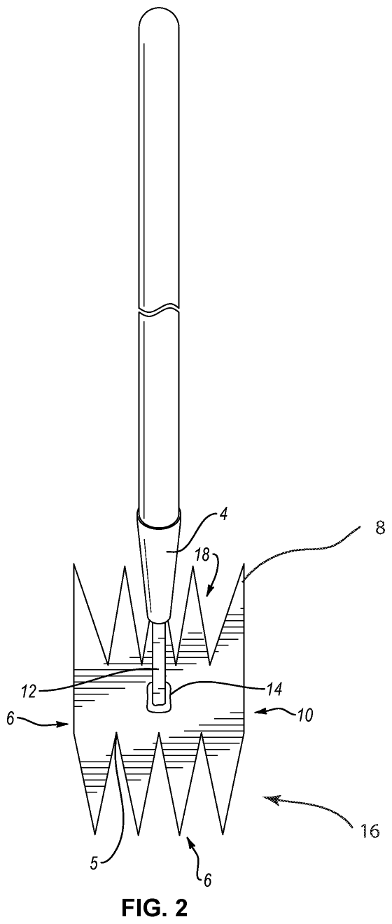

In FIG. 2, is top down view of a gardening tool, as shown in FIG. 1. In this embodiment, the gardening head 10 can be seen with the first point section 18, the intermediate section 6, and the second point section 16. Further the five V-shaped point 8 of the first point section 18, and the three V-shaped notch 5 of the second point section 16 can be seen, along with their corresponding V-shaped notches and points.

In this embodiment, the first point section 18 has 5 V-shaped points, and the second point section 16 has 4 V-shaped points. This embodiment also shows the second point section's 16 V-shaped notches are where the corresponding first point section's 18 V-shaped points are located, and vice versa. This is because, during manufacturing, this shape and embodiment allows for quick stamping of the head member shape with minimal amount of scrap, or for easy manufacturing out of one square piece of metal as mentioned above.

FIG. 2 also shows the attachment point 14. In this close up view of the FIG. 1 gardening tool, the attachment point is shown welded with the weld rivets, but further explanation of the attachment point is shown below.

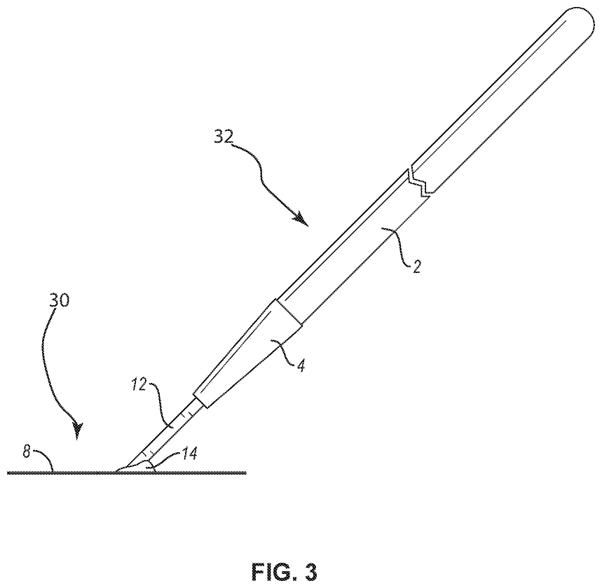

FIG. 3 is a side view of the gardening tool as shown in FIG. 1. In this embodiment, the head member 30 is shown attached to the elongated pole 32. The head member 30 is comprised of the intermediate section 6, the first point section 18, and the second point section 16, and the elongated pole is comprised of the elongated handle 12, the attachment piece 4, and the holding handle 2. In this embodiment, the head member 30 is attached to the elongated pole 32 at the attachment point.

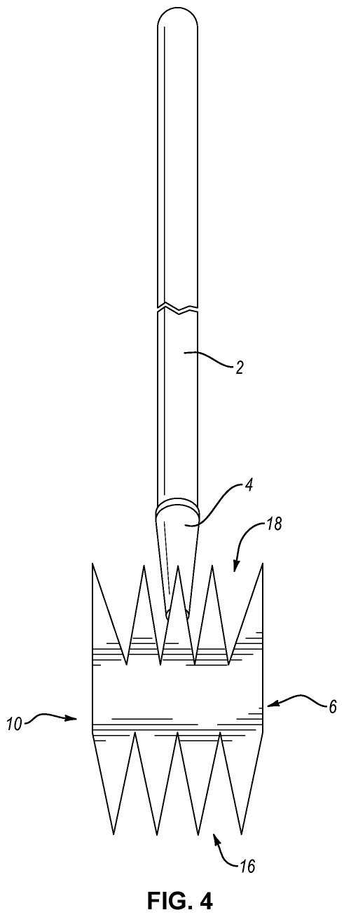

FIG. 4 is a bottom view of the gardening tool as shown in FIG. 1.

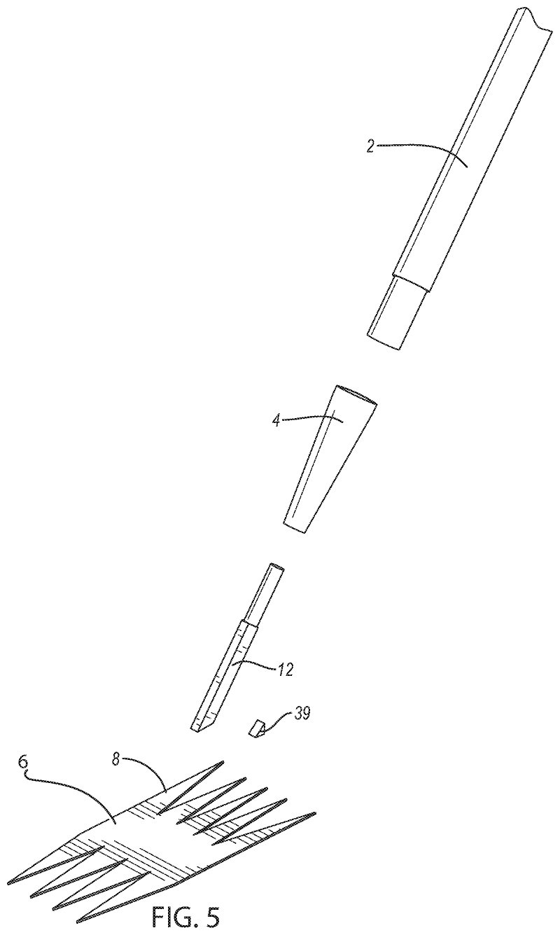

FIG. 5 is an exploded view of the gardening tool as shown in FIG. 1. In this view, it shows at the intermediate section 6 is located wedge 39. Wedge 39 is attached to the intermediate section 6 by welding, or any other attachment means commonly used in metal working. The elongated handle 12 can by a rectangular shaped pole, as shown, or cylindrical in shape. The bottom of the elongated handle is cut at such an angle to allow the elongated handle to rest against the intermediate section 6 of the head member on the bottom, and the wedge 39 on it's back side as shown in this view. This allows the elongated handle 12 to be able to have a stronger attachment to the head member because there is more metal surface to weld the elongated handle 12 to the head member and the wedge 39. FIGS. 1, 2, 3, and 6 show examples of elongated handle 12 after the weld has been made.

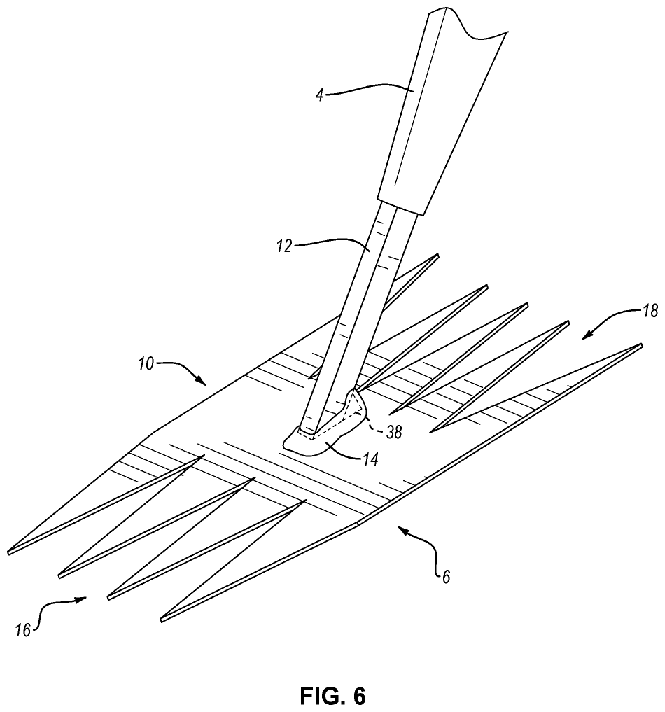

FIG. 6 is a close-up view of the head member of the gardening tool as shown in FIG. 1. This figures also shows the weld 38 that is applied on top of the wedge and the base of the elongated handle 12.

While preferred and alternate embodiments have been illustrated and described, as noted above, many changes can be made without departing from the spirit and scope of the Pinch Point Pull Hoe. Accordingly, the scope of the Pinch Point Pull Hoe is not limited by the disclosure of these preferred and alternate embodiments. Instead, the scope of the Pinch Point Pull Hoe is determined entirely by reference to the claims. Insofar as the description above and the accompanying drawings (if any) disclose any additional subject matter that is not within the scope of the claims below, the inventions are not dedicated to the public and Applicant hereby reserves the right to file one or more applications to claim such additional inventions.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example of a generic series of equivalent or similar features.

Any element in a claim that does not explicitly state “means for” performing a specified function, or “step for” performing a specific function is not to be interpreted as a “means” or “step” clause as specified in 35. U.S.C. § 112 ¶ 6. In particular, the use of “step of” in the claims herein is not intended to invoke the provisions of U.S.C. § 112 ¶ 6.

What is claimed is:

1. A gardening tool for performing controlled hacking strokes or oblique upward cuts, as well as downward chipping and chopping on weeds and small plants and limbs, or the like, comprising:
a head member, said head member further comprising a first point section, an intermediate section, and a second point section, whereby said first point section is offset from the intermediate section and the second point section is offset opposite to the first point section from the intermediate section;
an elongated handle, wherein said head member is attached to said elongated handle and a wedge located on the intermediate section of said head member.

2. The gardening tool of claim 1, wherein said wedge is a three-dimensional triangular shaped member that is capable of strengthening the attachment of the head member to the elongated handle by providing more attachment points.

3. The gardening tool of claim 3, wherein a bottom of the elongated handle and the wedge are welded to the head member.

4. The gardening tool of claim 1, where said second point section is comprised of four V-shaped points.

5. The gardening tool of claim 4, wherein said first point section is comprised of five V-shaped points.

6. The gardening tool of claim 1, wherein said head member is stamped out of or cut from a single piece of metal.

7. The gardening tool of claim 1, wherein the elongated handle is attached to an attachment piece.

8. The gardening tool of claim 7, wherein the attachment piece is further connected to a holding handle 2.

9. The gardening tool of claim 1, wherein the second point section is comprised of three V-shaped notches.

10. The gardening tool of claim 9, wherein the first point section is comprised of four V-shaped notches.
